(19) United States
(12) Patent Application Publication
(10) Pub. No.: US 2023/0309588 A1
(43) Pub. Date: Oct. 5, 2023

(54) CORN POPPER WITH AGITATOR

(71) Applicant: Franklin's Popcorn, Inc., Seattle, WA (US)

(72) Inventors: Jon C. Lake, Sunnyvale, CA (US); Dillon J. French, Menlo Park, CA (US); Cory Newton, East Palo Alto, CA (US); Josh Morenstein, San Francisco, CA (US); Christopher Hibmacronan, Berkeley, CA (US); Jakob Teifenbacher, San Francisco, CA (US); Ben Hoffman, San Francisco, CA (US)

(21) Appl. No.: 18/194,474

(22) Filed: Mar. 31, 2023

Related U.S. Application Data
(60) Provisional application No. 63/381,532, filed on Oct. 28, 2022.
(60) Provisional application No. 63/362,354, filed on Apr. 1, 2022.

(51) Int. Cl. A23L 7/183

(52) U.S. Cl. CPC A23L 7/183

(57) ABSTRACT

Devices for popping corn can include a pot, a lid assembly configured to mate with the pot, and an agitator assembly configured to be positioned within an interior volume of the pot, and to releasably engage the lid assembly when the lid assembly is mated with the pot. The agitator assembly can include at least one blade configured to cause un-popped kernels of corn within the pot to tumble as the agitator assembly is rotated within the pot, to help prevent sticking and burning of the kernels. The agitator assembly also can include at least one arm that transmits torque to the blade. The arm can be offset laterally from the axis of rotation of the agitator assembly.

### BACKGROUND

Stovetop popcorn poppers are widely used to prepare popcorn in home and other settings. Stovetop popcorn poppers typically include a pot and a lid. Un-popped kernels of corn are loaded into the interior volume of the pot. Other ingredients, such as oil, sugar, and salt, can be added along with the kernels. The interior volume is covered with the lid, and the pot and its contents are heated by a heating source such as a stovetop burner.

The heating of the kernels eventually causes the kernels to pop. The kernels contacting the bottom interior surface of the pot, however, experience the most heating, and thus are prone to burning before all of the kernels within the pot have been popped. Also, the oil, sugar, and salt within the pot can harden during the popping process, causing the kernels and the popped corn to stick to the interior surface of the pot.

Mechanisms have been incorporated into stovetop popcorn poppers to stir the kernels during the heating process. These mechanisms, however, typically push the kernels along the bottom surface of the pot, and thus may not prevent the bottom-most kernels from burning or sticking. Also, stirring mechanisms attached to the lid typically cause some of the popped corn to spill out of the pot as the lid is removed, and require at least partial disassembly to facilitate effective cleaning of the lid and the stirring mechanism by hand or in a dishwasher.

### SUMMARY

In another aspect of the disclosed technology, a device for popping corn includes a pot having one or more interior surfaces defining an interior volume of the pot. The device also includes a lid assembly having a lid configured to mate with the pot; a crank coupled to and configured to rotate in relation to the lid; and a linkage coupled to and configured to rotate with the crank. The device further includes an agitator assembly configured to be positioned within the interior volume of the pot, and to releasably engage the linkage when the lid is mated with the pot.

In another aspect of the disclosed technology, the agitator assembly is further configured to disengage from the lid assembly when the lid assembly is removed from the pot.

In another aspect of the disclosed technology, the agitator assembly includes a rim, a lower portion, and at least one arm. The at least one arm includes a first end connected to the rim, and a second end connected to the lower portion.

In another aspect of the disclosed technology, the lower portion incudes at least one blade configured to engage kernels of un-popped corn resting on at least one of the one or more interior surfaces of the pot.

In another aspect of the disclosed technology, the linkage includes a bar connected to the grip; a cross member connected to the bar, and at least one arm connected to the cross member and configured to removably engage the rim of the agitator assembly.

In another aspect of the disclosed technology, the at least one arm of the linkage is further configured to disengage from the rim when the lid assembly is removed from the pot.

In another aspect of the disclosed technology, the rim of the agitator assembly includes a plurality of undulations; and the at least one arm of the linkage is configured to removably engage the rim via one of the undulations when the agitator assembly is removably engaged with the linkage.

In another aspect of the disclosed technology, the lid has an arcuate opening formed therein and extending between interior and exterior surfaces of the lid.

In another aspect of the disclosed technology, the crank includes a shaft having a first end configured to be connected to the linkage. The shaft extends from the lid in a first direction. The crank also includes a first arm connected to a second end of the shaft. The first arm extends from the shaft in a second direction substantially perpendicular to the first direction. The crank further includes a second arm connected to the second end of the shaft and to an end of the first arm. The second arm extends from the first arm and the shaft in a third direction substantially perpendicular to the first direction and substantially opposite the second direction.

In another aspect of the disclosed technology, the device further includes a post secured to the pot and located within the interior volume of the pot. The post includes base, a body adjoining the base, and a key that adjoins the body. The post is configured to engage the lower portion of the agitator assembly, and the agitator assembly is configured rotate about the post. The lower portion of the agitator has a through hole formed therein and configured to receive the body of the post, and the through hole is configured so that the lower portion of the agitator can be separated from the post only when the a keyhole portion and the key are aligned.

In another aspect of the disclosed technology, the device further includes a post secured to the pot and located within the interior volume of the pot; and a knob. The post includes a base, a body adjoining the base, and a key that adjoins the body. The post is configured to engage the lower portion of the agitator assembly, and the agitator assembly is configured rotate about the post. The lower portion of the agitator has a through hole formed therein and configured to receive the body of the post, and the knob is configured to threadably engage the post, and to retain the lower portion of the agitator assembly on the post.

In another aspect of the disclosed technology, the first and second arms of the crank are spaced apart from the lid.

In another aspect of the disclosed technology, a device for popping corn includes a pot having one or more interior surfaces defining an interior volume of the pot. The device also includes a lid assembly having a lid configured to mate with the pot; a crank coupled to and configured to rotate in relation to the lid; and a linkage coupled to and configured to rotate with the crank. The device further includes an agitator assembly configured to be positioned within the interior volume of the pot.

The agitator assembly incudes at least one arm configured to be coupled to the linkage so that the agitator assembly rotates with the linkage, and a lower portion connected to the at least one arm. The at least one arm is laterally offset from an axis of rotation of the agitator assembly.

In another aspect of the disclosed technology, the lower portion includes at least one blade configured to engage kernels of un-popped corn resting on at least one of the one or more interior surfaces of the pot.

In another aspect of the disclosed technology a distance between the at least one arm and the axis of rotation of the agitator assembly is greater than a distance between the at least one arm and a sidewall of the pot when the agitator assembly is positioned within the interior volume of the pot.

In another aspect of the disclosed technology, the at least one arm is located proximate a sidewall of the pot when the agitator assembly is positioned within the interior volume of the pot.

In another aspect of the disclosed technology, the agitator assembly further includes a rim. A first end of the at least one arm is connected to the rim; and a second end of the at least one arm is connected to the lower portion of the agitator assembly.

In another aspect of the disclosed technology, the rim has a maximum diameter about equal to an inner diameter of the pot.

In another aspect of the disclosed technology, the rim is generally circular.

In another aspect of the disclosed technology, the linkage includes a bar connected to the grip; a cross member connected to the bar, and at least one arm connected to an end of the cross member and configured to engage the rim of the agitator assembly.

In another aspect of the disclosed technology, the cross-member extends transversely in relation to the axis of rotation of the agitator assembly when the lid is mated with the pot.

In another aspect of the disclosed technology, a device for popping corn includes a pot having a sidewall having an interior surface, and a bottom adjoining the sidewall and having an upper surface. The interior surface of the sidewall and the upper surface of the bottom define an interior volume of the pot. The device also includes an agitator assembly having at least one blade. The agitator assembly is configured to be positioned within the interior volume of the pot, and to rotate in relation to the pot.

The pot is configured to hold kernels of un-popped corn within the interior volume of the pot. The at least one blade is configured to contact the un-popped kernels of corn resting on the upper surface of the bottom of the pot, and to cause the un-popped kernels of corn resting on the upper surface of the bottom of the pot to tumble as the agitator assembly rotates in relation to the pot.

In another aspect of the disclosed technology, the at least one blade is angled in relation to the upper surface of the bottom of the pot.

In another aspect of the disclosed technology, the device further includes a lid assembly. The lid assembly has a lid configured to mate with the pot; a crank coupled to and configured to rotate in relation to the lid; and a linkage coupled to and configured to rotate with the crank. The agitator assembly is coupled to the linkage and is configured to rotate with the linkage.

In another aspect of the disclosed technology, the at least one blade has a leading edge; and the leading edge is spaced apart from the upper surface of the bottom of the pot.

In another aspect of the disclosed technology, the pot further includes a post mounted on the upper surface of the bottom of the pot. The post is configured to suspend the at least one blade of the agitator above the upper surface of the bottom of the pot.

In another aspect of the disclosed technology, the at least one blade includes an upper surface, and the at least one blade is configured so that the un-popped kernels of corn resting on the upper surface of the bottom of the pot are lifted up and over the upper surface as the agitator assembly rotates in relation to the pot.

In another aspect of the disclosed technology, the at least one blade is angled in relation to the upper surface of the bottom of the pot by about 14.5 degrees.

In another aspect of the disclosed technology, the at least one blade includes a first and a second blade. The agitator assembly further incudes a rim; and a first and a second arm each having a first end connected to the rim, and a second end. The agitator assembly also includes a lower portion having the first and second blade, and an intermediate portion adjoining, and positioned between the first and second blades. The second end of the first arm of the agitator assembly is connected to the first blade; and the second end of the second arm of the agitator assembly is connected to the second blade.

### DESCRIPTION OF THE DRAWINGS

The accompanying drawings, which are incorporated herein and constitute part of this specification, are illustrative of particular embodiments of the present disclosure and do not limit the scope of the present disclosure. The drawings are not to scale and are intended for use in conjunction with the explanations in the following detailed description.

FIG. 1 is a side view of a device for popping corn, with a lid assembly of the device installed on a pot of the device.

FIG. 2 is an exploded perspective view of the device shown in FIG. 1.

FIG. 3 is a cross-sectional side view of the device shown in FIGS. 1 and 2, with a lid assembly installed on a pot assembly of the device.

FIG. 4 is a magnified view of the area designated “B” in FIGS. 3 and 15.

FIG. 5 is a bottom view of a base laminate of the pot assembly shown in FIGS. 1-4.

FIG. 6 is a side view of a disk of the pot assembly shown in FIGS. 1-5.

FIG. 7. is a top perspective view of an agitator assembly of the device shown in FIGS. 1-6.

FIG. 8 is a top perspective view of a clip of the agitator assembly shown in FIG. 7.

FIG. 9 is a magnified view of the area designated “B” in FIG. 3, rotated 90 degrees from the perspective of FIG. 4.

FIG. 10 is a cross-sectional view of the lid assembly of the device shown in FIGS. 1-9.

FIG. 11 is a cross-sectional view of a grip of the lid assembly shown in FIG. 10.

FIG. 12 is an exploded perspective view of the lid assembly shown in FIGS. 10 and 11.

FIG. 13 is a top perspective view of an upper bar of a linkage of the lid assembly shown in FIGS. 10-12.

FIG. 14 is a cross-sectional view of a bushing of the device shown in FIGS. 1-13.

FIG. 15 is a cross-sectional side view of the device shown in FIGS. 1-14, showing a user grasping a grip of the lid assembly to remove the lid assembly from the pot.

FIG. 16 is a magnified view of the area designated “C” in FIG. 10.

FIG. 17 is a top perspective view of a bottom portion of a knob of the lid assembly shown in FIGS. 10-16.

FIG. 18 is a bottom view of a washer of the device shown in FIGS. 1-17.

FIG. 19 is a top perspective view of an alternative embodiment of the agitator assembly of the device shown in FIGS. 1-18.

FIG. 20 is a top-side perspective view of another alternative embodiment of the agitator assembly of the device shown in FIGS. 1-18.

FIG. 21 is a bottom perspective view of the lid assembly of the device shown in FIGS. 1-18, with another alternative embodiment of the agitator assembly engaging the lid assembly.

FIG. 22 is a top perspective view of the device shown in FIGS. 1-18, with another alternative embodiment of the agitator assembly installed in the pot of the device, and with the lid of the device removed.

FIG. 23 a top perspective view of the agitator assembly shown in FIG. 22.

FIG. 24 is a cross-sectional view of the device shown in FIG. 22, taken through the line XXIV of FIG. 22.

FIG. 25 is a cross-sectional view of the device shown in FIG. 22, taken through the line XXV of FIG. 22.

FIG. 26 is a side view of the agitator assembly shown in FIG. 23.

FIG. 27 is a top perspective view of the device shown in FIGS. 1-18, with another alternative embodiment of the agitator assembly installed in the pot of the device, and with the lid of the device removed.

FIG. 28 is a cross-sectional view of the device shown in FIG. 27, taken through the line XXVIII of FIG. 27.

FIG. 29 is a magnified view of the area designated “D” in FIG. 28.

### DETAILED DESCRIPTION

The following discussion omits or only briefly describes conventional features of the disclosed technology that are apparent to those skilled in the art. It is noted that various embodiments are described in detail with reference to the drawings, in which like reference numerals represent like parts and assemblies throughout the several views. Reference to various embodiments does not limit the scope of the claims appended hereto. Additionally, any examples set forth in this specification are intended to be non-limiting and merely set forth some of the many possible embodiments for the appended claims. Further, particular features described herein can be used in combination with other described features in each of the various possible combinations and permutations.

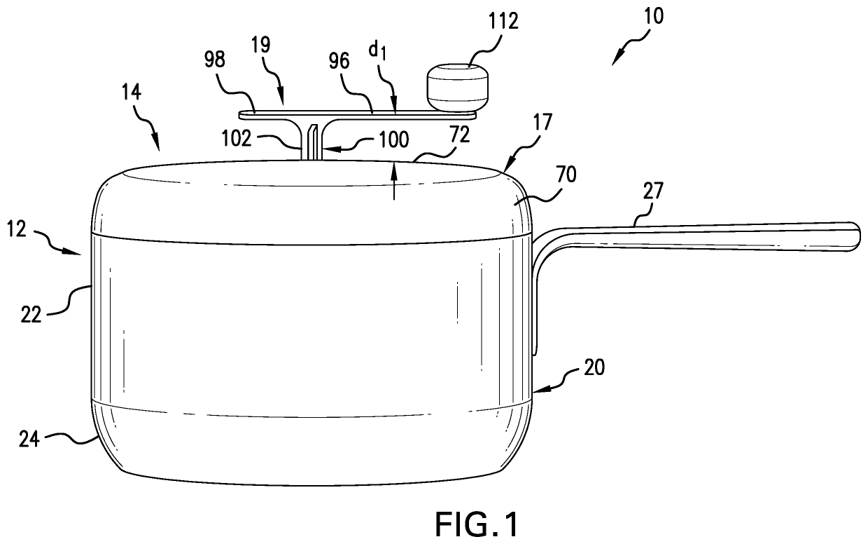

Directional terms such as up, down, upper, lower, top, bottom, etc. are used with reference to the component orientations depicted in FIGS. 1 through 4. These terms are used for illustrative purposes only, and are not intended to limit the scope of the appended claims.

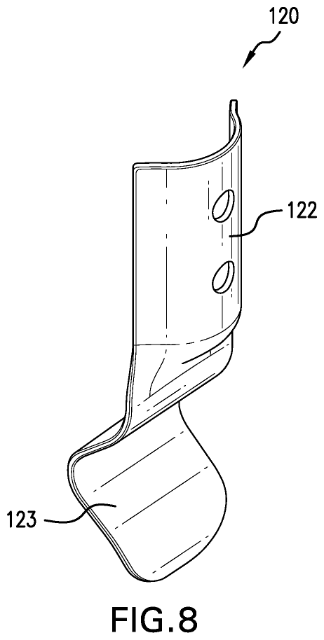

FIGS. 1-29 depict a device 10 for popping corn. The device 10 is configured for use on a stovetop burner or other heating source (not shown). The device 10 can be used in applications other than popping corn, including, for example, coffee bean roasting, nut roasting and mixing, etc.

Referring to FIGS. 1-3, the device 10 includes a pot assembly 12; a lid assembly 14; and an agitator assembly 16 that rests within the pot assembly 12. The lid assembly 14 comprises a lid 17 configured to cover the pot assembly 12. The lid assembly 14 also includes a linkage 18, and a crank or grip 19 that permits a user to rotate or spin the agitator assembly 16 when the lid 17 is covering the pot assembly 12. The agitator assembly 16 is configured to stir un-popped kernels of corn resting on the bottom of the pot assembly 12, to prevent the kernels from sticking to the pot assembly 12 and burning. The stirring action can be especially useful when the device 10 is being used to make kettle corn, where the oil, sugar, and salt added to the pot assembly 12 make the kernels especially prone to sticking. The linkage 18 separates automatically from the agitator assembly 16 when the lid assembly 14 is removed from the pot assembly 12, so that the agitator assembly 16 and can remain in the pot assembly 12 while the popped corn is emptied from the pot assembly 12. After the pot assembly 12 is emptied, the user can remove the agitator assembly 16 from the pot assembly 12 for cleaning or other purposes, without spilling any of the popped corn and without a need to remove any fasteners or otherwise disassemble any components of the device 10.

Pot Assembly 12

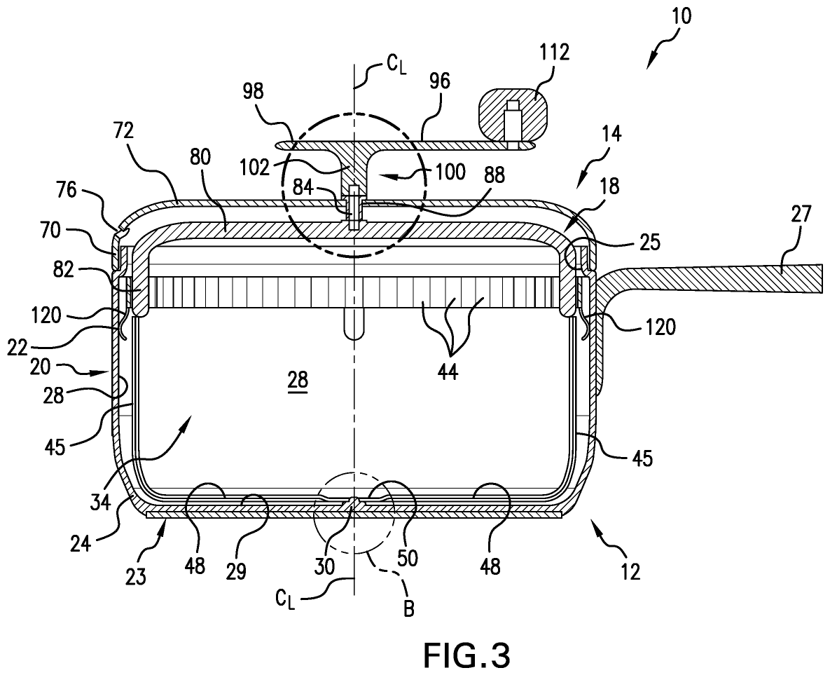

Referring to FIGS. 1-4, the pot assembly 12 has a pot 20. The pot 20 includes an upper portion 22 having a substantially flat profile when viewed in cross-section, as shown in FIG. 3. The upper portion 22 has a substantially circular profile when viewed from above. The pot 20 further includes a lower portion 24 that adjoins the upper portion 22. The lower portion 24 has a curvilinear profile when viewed in cross-section, as shown in FIG. 3. The upper portion 22 and the lower portion 24 can have other shapes in alternative embodiments. The upper portion 22 and the lower portion 24 form a sidewall of the pot 20.

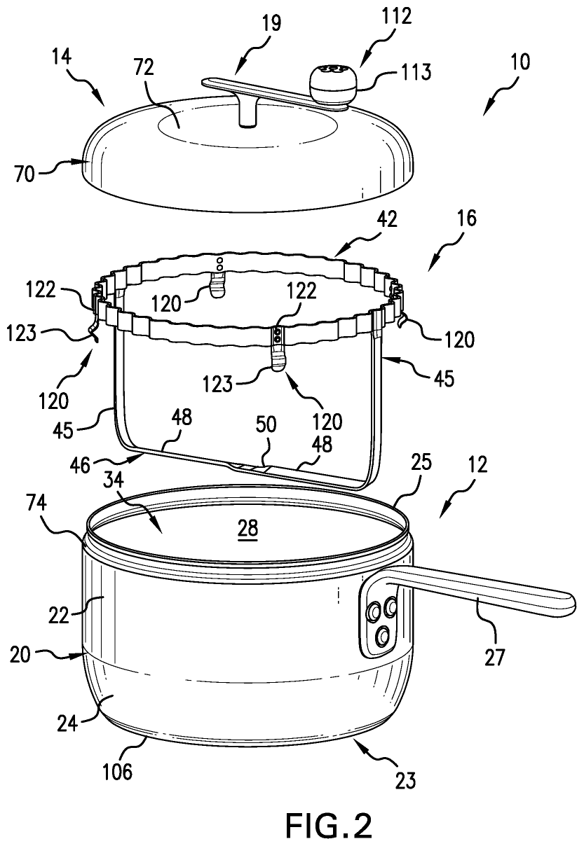

The pot 20 also includes a lip 25 that adjoins, and extends upward from an upper end of the upper portion 22. As can be seen in FIGS. 2 and 3, the lip 25 has a diameter less than that of the upper portion 22. The lip 25 is configured to engage the lid 17, and to retain the lid 17 on the pot assembly 12 by way of friction between the contacting surfaces of the lip 25 and the lid 17.

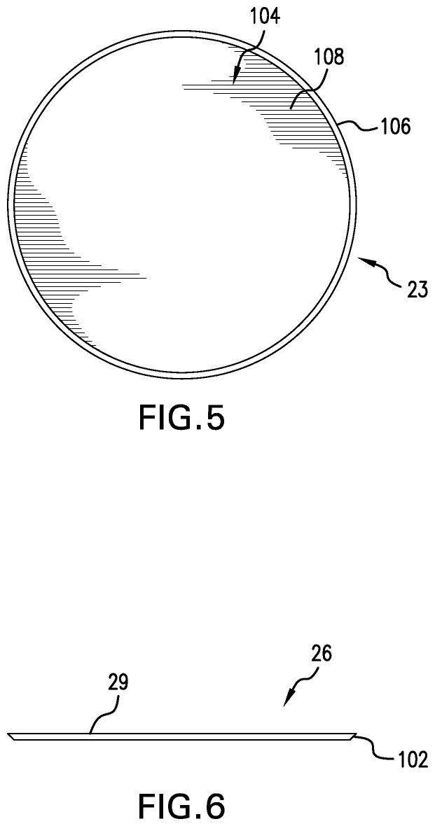

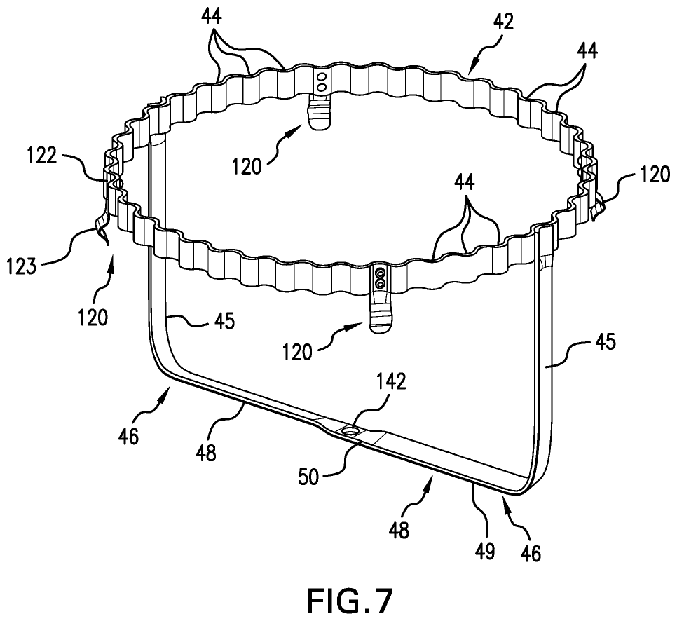

Referring to FIGS. 5 and 6, the pot 20 further comprises a base laminate 23 and a disk 26 that together form a bottom of the pot 20. The disk 26 is substantially flat as viewed from the side, as shown in FIG. 7; and is substantially circular as viewed from above, as can be seen in FIG. 5. An outer circumferential surface 102 of the disk 26 is angled upwardly and outwardly, as shown in FIG. 6. The outer circumferential surface 102 of the disk 26 can be angled in relation to the horizontal direction by, for example, about 45 degrees. The outer circumferential surface 102 can have other orientations in alternative embodiments. The disk 26 has an upper surface 29, as shown in FIG. 6.

The base laminate 23 incudes a body 104. The body 104 is substantially flat as viewed from the side; and is substantially circular as viewed from below, as shown in FIG. 5. The base laminate 23 also includes a lip 106 that extends around an outer circumference of the body 104. The lip 106 has an orientation that substantially matches the orientation of the outer circumferential surface 102 of the disk 26. The base laminate 23 has a lower surface 108, visible in FIG. 5.

The base laminate 23 and the disk 26 are configured so that the disk 26 rests on the base laminate 23, within a space defined by the upper surface of the body 104, and an inner surface of the lip 106; and with the outer circumferential surface 102 of the disk 26 contacting the inner surface of the lip 106.

The base laminate 23, the disk 26, and the lower portion 24 of the pot 20 can be joined as follows. First, the disk 26 can be spot welded to the lower portion 24. The base laminate 23 then can be spot welded to the disk 26. The resulting assembly can be heated until the disk 26 begins to melt, and the assembly can be pressed together at a high temperature. The base laminate 23, the disk 26, and the lower portion 24 can be joined using other techniques in alternative embodiments.

Once the base laminate 23 and the disk 26 are jointed to the pot 20, the lower surface 108 of the base laminate 23 forms the bottom surface of the pot 20. The device 10 rests on the lower surface 108, and can be heated by a stovetop burner or other heating source acting on the lower surface 108. The base laminate 23 and the disk 26 form a bottom of the pot 12. Alternative embodiments of the pot 12 have a one-piece bottom base in lieu of the two-piece laminate 23 and the disk 26.

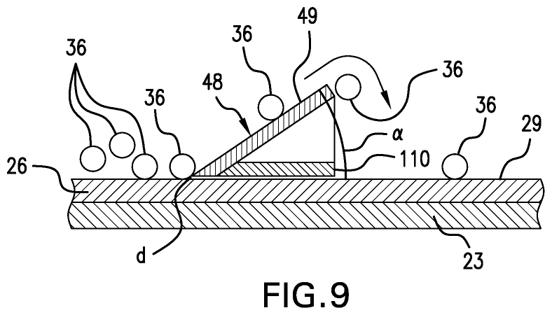

Once the base laminate 23 and the disk 26 are mated with the lower portion 24, an upper surface 29 of the disk 26, together with an inner surface 28 of the pot 20, define an interior volume 34 of the pot assembly 12. The interior volume 34 holds kernels 36 of corn to be heated and popped, with the kernels resting on the upper surface 29. The kernels 36 are depicted in FIG. 9. The inner volume 34 is depicted in FIGS. 2 and 3.

The pot 20 is formed from one or more rigid materials suitable for use at the temperatures generated by a conventional stovetop burner, and suitable for contact with food to be consumed by humans. For example, the upper portion 22, lower portion, 24, lip 25, and base laminate 23 can be formed from stainless steel, and the disk 26 can be formed from aluminum. The upper portion 22, lower portion, 24, lip 25, and base laminate 23 can be formed from materials other than stainless steel, such as aluminum or cast iron, in the alternative. The disk 26 likewise can be formed from materials other than aluminum, such as stainless steel or cast iron, in the alternative.

The upper surface 29 of the disk 26 and the inner surface 28 of the pot 20 can be coated with a nonstick coating such as polytetrafluoroethylene (PTFE). Other types of nonstick coatings can be used in the alternative. Other alternative embodiments can be configured without a nonstick coating. The interior volume 34 has a capacity of about six quarts. Alternative embodiments of the pot assembly 12 can be configured so that the interior volume 34 has a capacity of less, or more than six quarts.

The pot assembly 12 further includes a handle 27. The handle 27 is secured to an exterior surface of the upper portion 22 of the pot 20, as shown in FIGS. 1 and 2. The handle 27 can facilitate lifting of the device 10 as the device 10 is placed on and removed from the heating source. The handle 27 can be secured to the pot 20 by rivets or other suitable means.

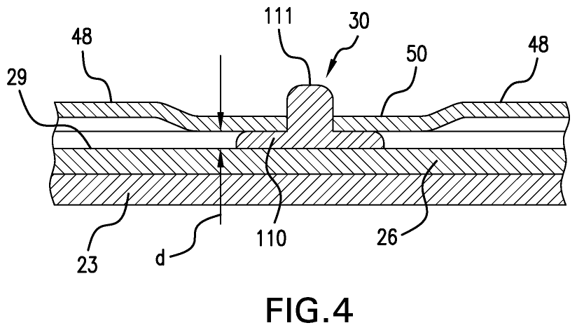

The pot assembly 12 also includes a post 30, shown in FIGS. 3 and 4. The post 30 incudes a base 110, and a projection 111 that adjoins, and extends upward from the base 110. The base 110 is fixed to the upper surface 29 of the disk 26 by a suitable means such as spin welding, and is positioned at the approximate geometric center of the upper surface 29 so that the projection 111 is substantially centered about a vertical centerline of the pot assembly 12. The vertical centerline of the pot assembly 12 is denoted in FIG. 4 by the line “CL.” As discussed below, the agitator assembly 16 is supported by, and rotates on the post 30. The post 30 can be formed from a rigid material, such as stainless steel, suitable for use at the temperatures generated by a conventional stovetop burner.

Agitator Assembly 16

As can be seen in FIGS. 3 and 4, the agitator assembly 16 is located within the interior volume 34, and rests on the post 30. The agitator assembly 16 is configured to be rotated within the pot assembly 12 by way of the linkage 18 of the lid assembly 14. As discussed below, the agitator assembly 16 is configured so that rotation of the agitator assembly 16 lifts un-popped corn kernels 36 from upper surface 29 of the disk 26, and causes the kernels 36 to tumble, helping to prevent the kernels 36 from sticking to the upper surface 29 and burning. The agitator assembly 16 can be installed in, and removed from the pot assembly 12 by the user, without a need to install or remove any fasteners or otherwise assemble or disassemble any components of the device 10.

Referring to FIG. 7, the agitator assembly 16 includes a rim or ring 42. The ring 42 is scalloped, i.e., the ring 42 is made up of a continuous series of undulations 44 along its entire length. The maximum diameter of the ring 42 is slightly smaller than the diameter of the adjacent portion of the interior surface 28 of the pot 20, so that the ring 42 is located proximate the interior surface 28, as shown in FIG. 3.

The agitator assembly 16 also includes four clips 120, visible in FIGS. 3, 7, and 8. Each clip 120 has an upper portion 122 and a lower portion 123. The upper portion 122 has an inwardly curved profile, and is sized and shaped to fit within one of the undulations 44 in the ring 42. The lower portion 123 is outwardly-curved, so that the lower portion 123 contacts the inner surface 28 of the pot 20 when the agitator assembly 16 is positioned with the pot assembly 12, as can be seen in FIG. 3. The lower portions 123 are located under, and engage the step 74 formed in the pot assembly 12. The engagement of the lower portions 123 and the step 74 retains the agitator assembly 16, and helps the agitator assembly 16 to remain in the pot assembly 12 when the pot assembly 12 is tilted or inverted, such as when the popped kernels 36 are being emptied from the pot assembly 12. The agitator is centered and held from contact with the inner surface of the rim of the pot by the arms 82. The upper portion 122 of each clip 120 is fixed to the ring 42 by a suitable means such as rivets. The clips 120 may be equally spaced around the circumference of the ring 42. Alternative embodiments of the agitator assembly 16 can include more, or less than four clips 120. Other alternative embodiments can be configured without any of the clips 120.

Referring to FIGS. 2 and 7, the agitator assembly 16 also includes two arms 45. Each arm 45 extends substantially in the vertical direction. An upper end of each arm 45 adjoins, and extends downward from the ring 42. The arms 45 are fixed to the ring 42 at diametrically opposed positions along the circumference of the ring 42, by a suitable means such as a resistance weld. Each arm 45 is angularly spaced from its two adjacent clips 120 by, for example, about 45 degrees. In alternative embodiments, the clips 120 can be located on, or proximate an associated one the arms 45, i.e., the clips 120 are not angularly spaced from their associated arms 45. The arms 45 can adjoin the ring 42 at non-diametrically-opposed positions along the circumference of the ring 42 in alternative embodiments. Other alternative embodiments of the agitator assembly 16 can include only one arm 45, or more than two arms 45.

Referring still to FIGS. 2 and 7, the agitator assembly 16 further includes a lower portion 46. The lower portion 46 includes two blades 48, and an intermediate member 50. A first end of each blade 48 adjoins a lower end of a respective one of the arms 45. A second end of each blade 48 adjoins a respective end of the intermediate member 50. The lower portion 46 and the arms 45 are unitarily formed. The lower portion 46 and the arms 45 can be formed separately, and can be connected by a suitable means, such as adhesive, ultrasonic welding, etc., in alternative embodiments.

As can be seen in FIG. 9, each blade 48 is configured so that a leading surface 49 the blade 48 is oriented at an angle in relation the upper surface 29 of the disk 26 of the pot assembly 12 when the agitator assembly 16 is positioned with the pot assembly 12. This angle is denoted by the character “a” in FIG. 9. The optimum value for the angle α is application dependent, and can vary with factors such as the average size of the kernels 36 to be popped in the device 10. Optimally, the angle α is selected so that the kernels 36 are lifted and tumbled by their interaction the blades 48 as shown in FIG. 9. The lifting and tumbling action encourages the kernels 36 to be heated evenly, without being scorched due to heating on only one side of the kernel 36. By contrast, at steep angles, or high values of a, e.g., 90 degrees, the kernels 36 are pushed, rather than lifted, so that the kernels 36 slide around in a circle on or near the upper surface 29 of the disk 26, without being tumbled. At a shallow angle, or low values of a, the lowest kernels 36 can slide up and over the upper surface of the blade 48, and then down onto the upper surface 29, without being tumbled. The tumbling provided by the blades 48 helps to prevent the sliding the kernels 46 along the upper surface 29, where the same surface of the kernel 46, e.g., the bottom surface of the kernel 46, remains constantly in contact with the hot upper surface 29, which in turn can result in burning of the kernel 46. The tumbling action provided by the blades 48 thus can facilitate a more even heat distribution throughout the kernel 46, so that the kernel 46 pops before burning.

As discussed below, the agitator assembly 16 is configured so that rotation of the agitator assembly 16 lifts un-popped corn kernels 36 from upper surface 29 of the disk 26, and causes the kernels 36 to tumble, helping to prevent the kernels 36 from sticking to the upper surface 29 and burning.

As a non-limiting example, the value of a can be about 14.5 degrees. As noted above, the optimal value for a is application-dependent, and can vary with factors such as the size of the kernels to be popped. Thus, alternative embodiments of the lower portion 46 can be configured so that a is greater, or less than about 14.5 degrees.

The intermediate member 50 rests on, and is supported by the post 30 of the pot assembly 12, at the approximate mid-point of the intermediate member 50, as can be seen in FIGS. 7 and 9. In particular, the intermediate member 50 has a through hole 142 formed therein, at its approximate mid-point. The through hole 142 is sized to receive the projection 111 of the post 30 with minimal clearance, so that the lower portion 46 of the agitator assembly 16 can rotate smoothly about the post 30. The through hole 142 is visible in FIG. 7. The portion of the intermediate member 50 adjacent the through hole 142 rests, and rotates on the base 110 of the post 30, as can be seen in FIGS. 3 and 4. In alternative embodiments, in lieu of the through hole 142, the intermediate member 50 can be configured with a centering feature, such as a cone or cylinder, that receives the projection 111 of the post 30.

The linkage 18 (including the arms 82) and the post 30 restrain the agitator assembly 16 radially, so that the agitator assembly 16 rotates about the vertical centerline CL of the pot assembly 12 as the agitator assembly 16 is spun by the user by way of the grip 19 and the linkage 18. The blades 48 are symmetrically disposed about the center of rotation of the agitator assembly 16, with the exception that the blades 48 are angled in reverse directions so that the blades 48 approach the un-popped kernels 36 on the upper surface 29 of the pot assembly 12 in approximately the same orientation in relation to the upper surface 29, as can be seen in FIG. 7.

As can be seen in FIGS. 4 and 9, a leading edge 54 of each blade 48 has an elevation, or vertical position, about equal to the elevation of the intermediate member 50. Thus, because the intermediate member 50 rests on the base 110 of the post 30, the intermediate member 50 and the leading edges 54 are spaced above the upper surface 29 of the pot assembly 12 by a distance about equal to the height of the base 110 above the upper surface 29. This distance is denoted in FIGS. 4 and 9 by the character “d,” and remains substantially constant as the intermediate portion 50 rotates on the base 110. And the centering effect of the post 30 and the linkage 18 (including the arms 82), helps to maintain the axis of rotation of the agitator assembly 16 approximately coincident with the centerline CL of the pot assembly 12.

The post 30 can be configured so that the distance “d” is large enough to prevent contact between the lower portion 46 of the agitator assembly 16 and the upper surface 29 of the pot assembly 12, but small enough to permit the blades 48 to contact the un-popped kernels 36 lying on the upper surface 29, and to lift or scoop the kernels 36 from the surface 29 as the agitator assembly 16 is rotated. As discussed above, the lifting action of the blades 48 is facilitated by the angled orientation of blades 48 in relation to the upper surface 29, as can be seen in FIG. 9. Once the kernels 36 have been lifted by the blades 48, the continued rotation of the blades 48 permits the kernels 36 to fall back down onto the upper surface 29. The movement of the kernels 36 imparted by the agitator assembly 16 helps to prevent the kernels 36 from sticking to the surface 29 and burning. The agitator assembly 16 also imparts movement to pieces of popped corn resting on the upper surface 29, to help prevent sticking and burning of the popped corn. As noted above, this feature can be especially useful when the device 10 is being used to make kettle corn, where the oil, sugar, and salt added to the pot assembly 12 make the kernels 36 and the popped corn especially prone to sticking. Also, the movement of the blades 48 proximate the upper surface 29 of the pot assembly 12 can help to prevent a build-up of oil, sugar, and salt on the upper surface 29.

The post 30 can be configured so that the distance “d” is greater than zero, and less than the diameter of a typical kernel 36 of un-popped corn. In some embodiments, “d” can be less than one-half the diameter of a typical kernel 36, to help ensure that substantially all of kernels 36 lying on the upper surface 29 of the disk 26 are lifted by the rotating blades 48 of the agitator assembly 16. For example, the base 110 of the post 30 can have a thickness, or vertical dimension, of about 2.0 mm, so that the distance d is about 2.0 mm. The base 110 can be configured so that the distance d is less, or more than 2.0 mm in alternative embodiments.

Means other than the post 30 can be used to support and elevate the agitator assembly 16 in alternative embodiments. For example, a pin or block can be mounted or otherwise formed on the upper surface 29 in lieu of the post 30, to support and elevate the agitator assembly 16. In other alternative embodiments, an upwardly-curved dimple can be formed in the center of the disk 26, in lieu of the post 30. In other alternative embodiments, a post, pin, block, dimple, or other supporting and elevating means can be incorporated into the intermediate member 50 instead of the disk 26. Other alternative embodiments can be configured without any means to elevate the agitator assembly 16, so that the leading edges 54 of the blades 48 rest on, and slide along the upper surface 29.

The agitator assembly 16 can be formed from stainless steel. The agitator assembly 16 can be formed from other materials in the alternative, such as stainless steel over-molded or coated with silicone or high-temperature plastic.

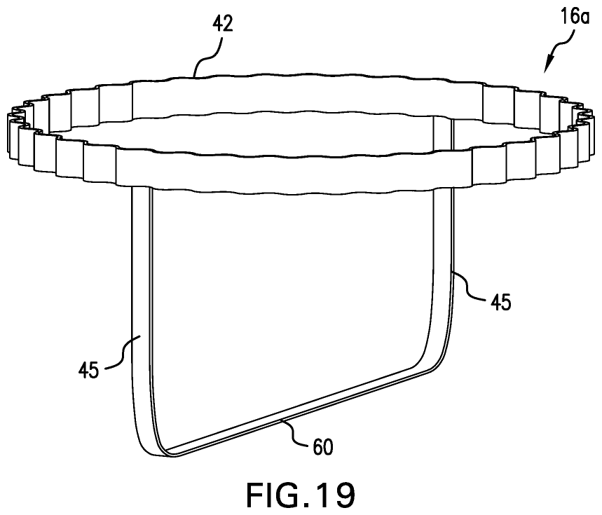

FIG. 19 depicts an alternative embodiment of the agitator assembly 16 in the form of an agitator assembly 16a. The agitator assembly 16a is substantially identical to the agitator assembly 16, with the exception that the agitator assembly 16a has a substantially flat blade 60 in lieu of the blades 48 and the intermediate member 50 of the agitator assembly 16. The blade 60 has a substantially parallel orientation in relation to the upper surface 29 of the disk 26 of the pot assembly 12. The substantially flat configuration of the blade 60 permits the agitator assembly 16a to operate effectively regardless of its direction of rotation. The agitator assembly 16, by contrast, can operate effectively when rotating in only one direction, due the angling of the blades 48.

In other alternative embodiments (not shown), the blades can have an A-shaped or tent-shaped cross section, with each side of the blade being angled in a manner similar to the blades 48. This configuration, like the blades 60, facilitates bidirectional operation of the agitator assembly.

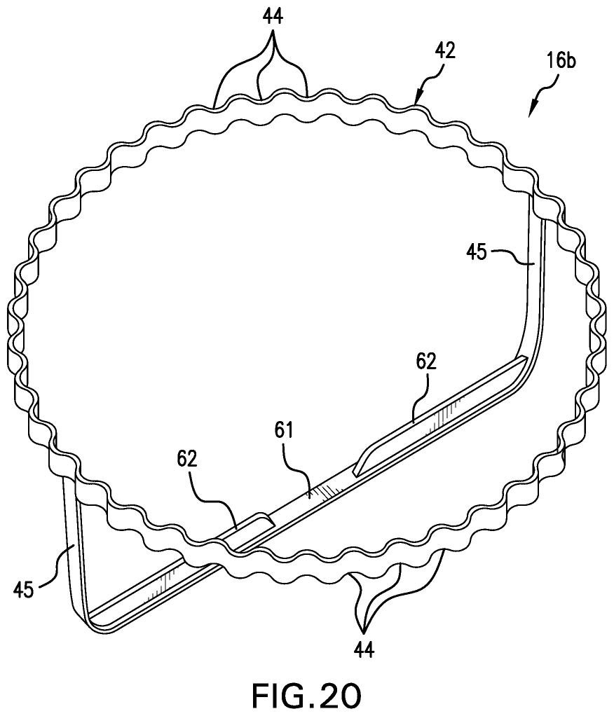

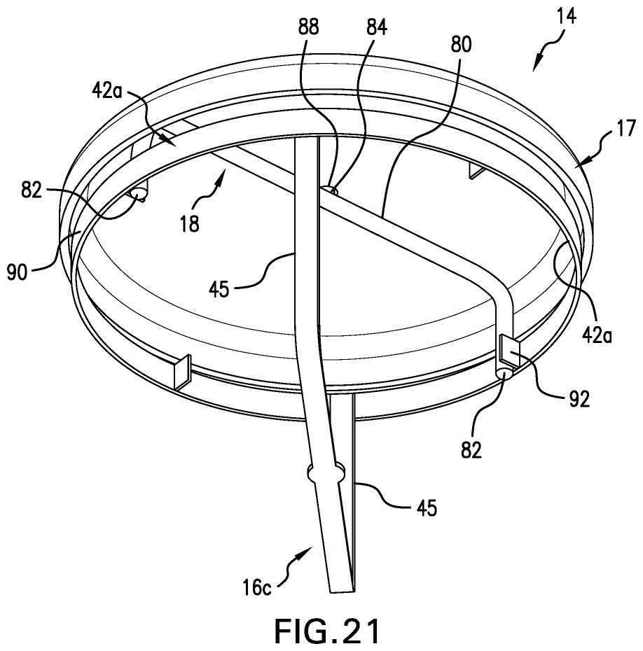

FIG. 20 depicts another alternative embodiment of the agitator assembly 16 in the form of an agitator assembly 16b. The agitator assembly 16b is substantially identical to the agitator assembly 16, with the exception that the agitator assembly 16b includes a substantially flat blade 61 and two tabs 62 that adjoin the blade 61, in lieu of the blades 48 and the intermediate member 50 of the agitator assembly 16. The blade 61 has a substantially parallel orientation in relation to the upper surface 29 of the disk 26 of the pot assembly 12, and the tabs 62 have a substantially perpendicular orientation in relation to the upper surface 29. The configuration of the blade 61 and the tabs 62 permits the agitator assembly 16b to operate effectively regardless of its direction of rotation. Alternative embodiments of the agitator assembly 16b can include only one tab 62, or more than two tabs 62.

FIG. 21 depicts another alternative embodiment of the agitator assembly 16 in the form of an agitator assembly 16c. The agitator assembly 16c is substantially identical to the agitator assembly 16a, with the exception that the agitator assembly 16c has a ring 42a comprising a substantially flat, circumferentially-extending ring 90, and four tabs 92. The tabs 92 adjoin, and extend radially inward from the ring 90; and each tab 92 is diametrically opposed to another one of the tabs 92. The diameter of the ring 90 is selected so that the arms 82 of the linkage 18 fit within the ring 90 with minimal, or no clearance. As can be seen in FIG. 21, each arm 82 engages a corresponding one of the tabs 92 as the linkage 18 is rotated, to that torque is transmitted to the agitator assembly 16c by way of the tabs 92. Variants of the agitator assembly 16c can include less, or more that four of the tabs 92.

The agitator assembly 16c differs from the agitator assembly 16a in the following additional aspect. The agitator assembly 16c includes a lower portion 60a having a recess formed in the bottom thereof, at the approximate mid-point of the lower portion 60a. The recess is visible in FIG. 21. The recess is configured to receive an upper end of the post 30 or other supporting structure. Variants of the agitator assembly 16, the agitator assembly 16a, and the agitator assembly 16b can be configured with such a recess.

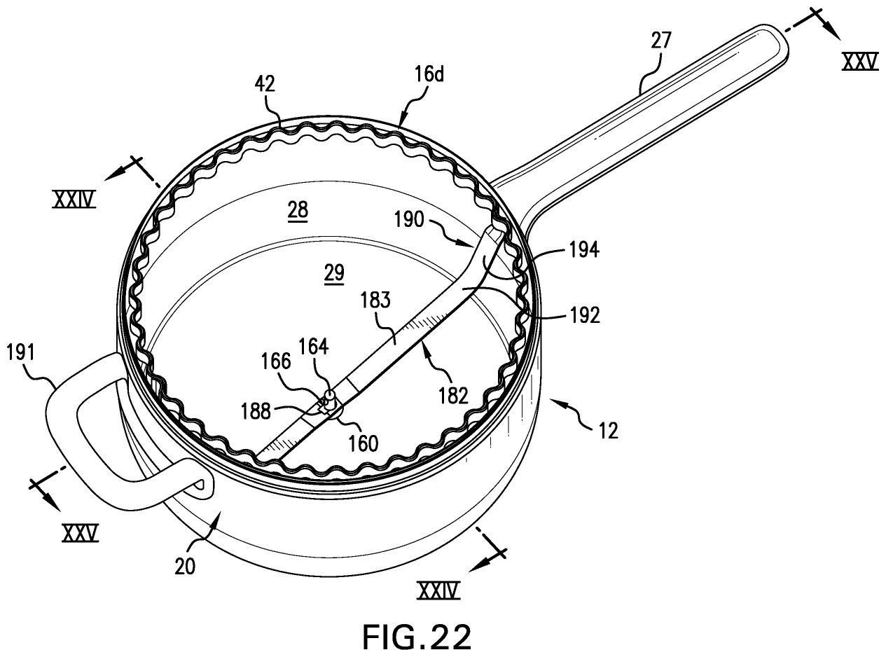

FIGS. 22-24 depict another alternative embodiment of the agitator assembly 16 in the form of an agitator assembly 16d. The agitator assembly 16d is substantially identical to the agitator assembly 16a, with the exception that the agitator assembly 16d includes arms 45a having an angled orientation, and the agitator assembly 16d coupled to the bottom of the pot.

FIGS. 22-26 depict another alternative embodiment of the agitator assembly 16 in the form of an agitator assembly 16d. The agitator assembly 16d is substantially identical to the agitator assembly 16a, with the exception that the agitator assembly 16d includes arms 190 having an angled orientation, and a post 160 that couples the agitator assembly 16d to the bottom of the pot assembly 12.

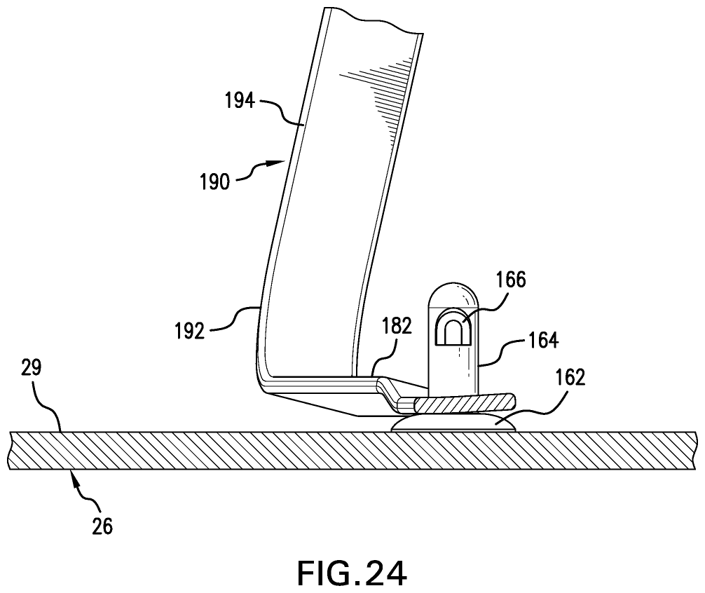

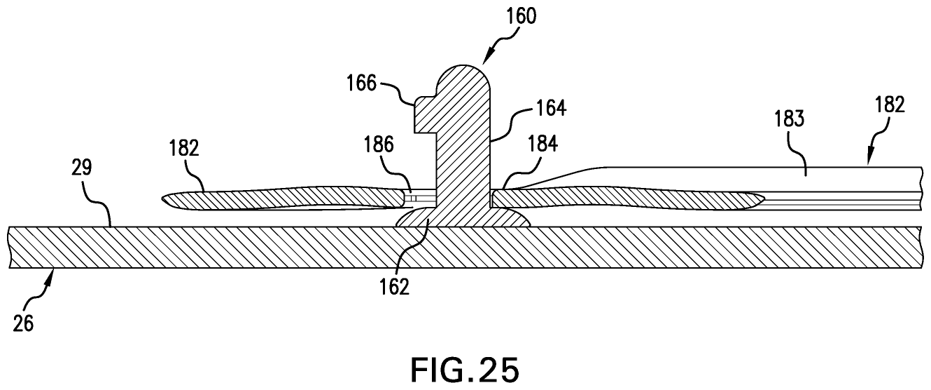

Referring to FIGS. 24 and 25, the post 160 has a base 162, and a body 164 that adjoins and extends upward from the base 162. The post 160 also includes a key 166 that projects from an upper portion of the body 164. The portion of the body 164 below the key 166 has a substantially circular cross section. The base 162 is secured to the upper surface 29 of the disk 26 by a suitable means such as adhesive. The base 162 is positioned at the approximate geometric center of the upper surface 29, as shown in FIG. 22.

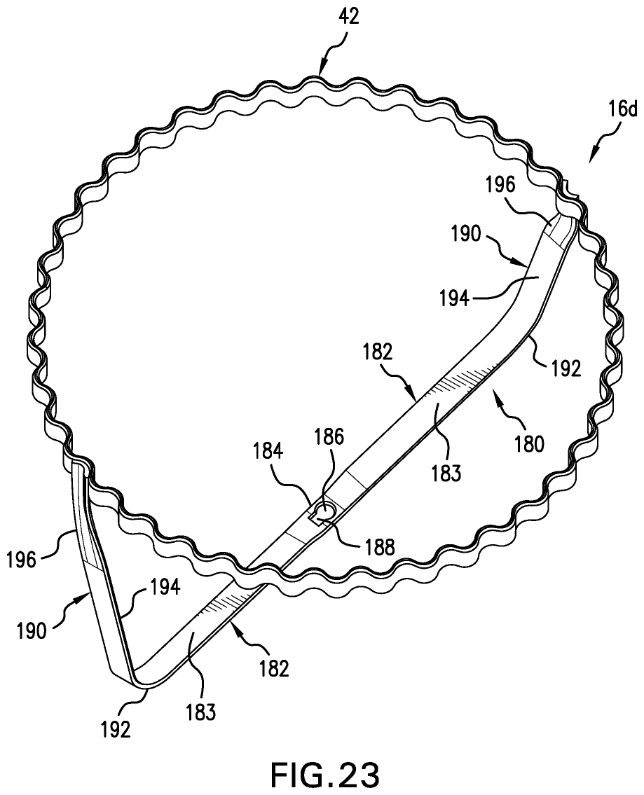

As can be seen in FIG. 23, a lower portion 180 of the agitator assembly 16d includes two blades 182, and an intermediate member 184 that adjoins, and is positioned between the blades 182. A first end of each blade 182 adjoins a lower end of a respective one of the arms 190. A second end of each blade 182 adjoins a respective end of the intermediate member 184.

As discussed above in relation to the blades 48, each blade 182 is configured so that a leading surface 183 of the blade 182 is oriented at an angle in relation the upper surface 29 of the disk 26 of the pot assembly 12 when the agitator assembly 16d is positioned within the pot assembly 12, so that the kernels 36 on the upper surface 29 are lifted and tumbled by their interaction the blades 182.

The intermediate member 184 rests on, and is supported by the base 162 of the post 160, at the approximate mid-point of the intermediate member 184, as can be seen in FIGS. 23-25. The intermediate member 184 has a through hole 186 formed therein, at its approximate mid-point. The through hole 186 receives the body 164 of the post 160. With the exception of a keyhole portion 188 of the through hole 186, the through hole 186 has a diameter slightly larger than the outer diameter of the lower portion of the body 164, i.e., the portion of the body 164 located below the key 166, so that the agitator assembly 16d can rotate smoothly about the post 160.

The through hole 186 is configured so that the intermediate member 184 of the agitator assembly 16d can be placed on and removed from the post 160 only when the keyhole portion 188 is aligned with the key 166 of the post 160 as shown in FIG. 22. In particular, the through hole 186 is sized so that the key 166 contacts the intermediate member 184 when the intermediate member 184 is raised or lowered in relation to the post 160, and the keyhole portion 188 not aligned with the key 166, i.e., the key 166 interferes with upward and downward movement of the intermediate member 184 over the body 164 in relation to the post 160 when the keyhole portion 188 is not aligned with the key 166. This in turn causes the agitator assembly 16d to remain coupled to the pot assembly 12 by way of the post 160 when the lid 17 is removed, and to remain in place within the pot assembly 12 as the user tilts or inverts the pot assembly 12 to empty the popped kernels 36 from the pot assembly 12.

When the user wishes to remove the agitator 16d for cleaning or other purposes, the user can rotate the agitator assembly 16d manually, after the lid 17 has been removed, until the keyhole portion 188 aligns with the key 166 as shown in FIG. 22. The agitator assembly 16d then can be lifted, with the key 166 passing through the keyhole portion 188 as the intermediate member 184 disengages from the post 160.

The agitator assembly 16d can be reinstalled in the pot assembly 12 by aligning the keyhole portion 188 with the key 166, and lowering the agitator assembly 16d so that the key 166 passes through the keyhole portion 188 as the intermediate member 184 re-engages the post 160.

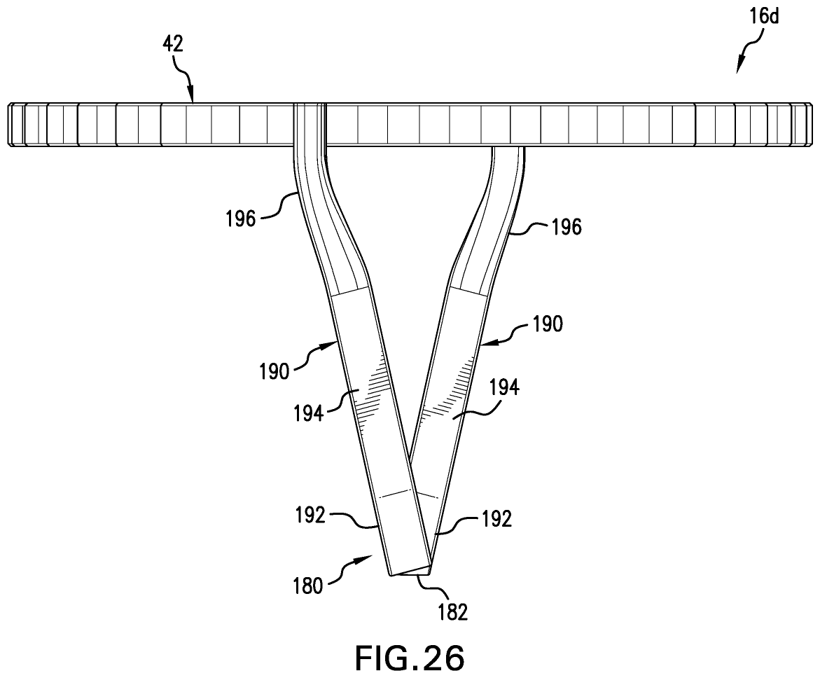

Referring to FIGS. 23 and 26, each arm 190 includes a lower portion 192; an intermediate portion 194 that adjoins the lower portion 192; and an upper portion 196 that adjoins the intermediate portion 194 and the ring 42.

The lower portion 192 of each arm 190 adjoins a corresponding one of the blades 182. The lower portion 192 is curved, and extends through an arc of about 90 degrees. The intermediate portion 194 is substantially straight, and is angled in relation to the vertical direction by an amount about equal to the angle between the leading surface 183 of the blade 182 and the upper surface 29 of the disk 26.

The upper portions 196 of the respective arms 190 are fixed to the ring 42 at diametrically opposed positions along the circumference of the ring 42, by a suitable means such as a resistance weld. Each of the upper portions 196 has a generally curved profile that causes the upper portion 196 to transition from the angled orientation of the intermediate portions 194 to a substantially vertical orientation suitable for engaging the scalloped ring 42.

As can be seen in FIG. 22, the pot assembly 12 includes a second handle 191 secured to the pot 20 at a position diametrically opposite the handle 27.

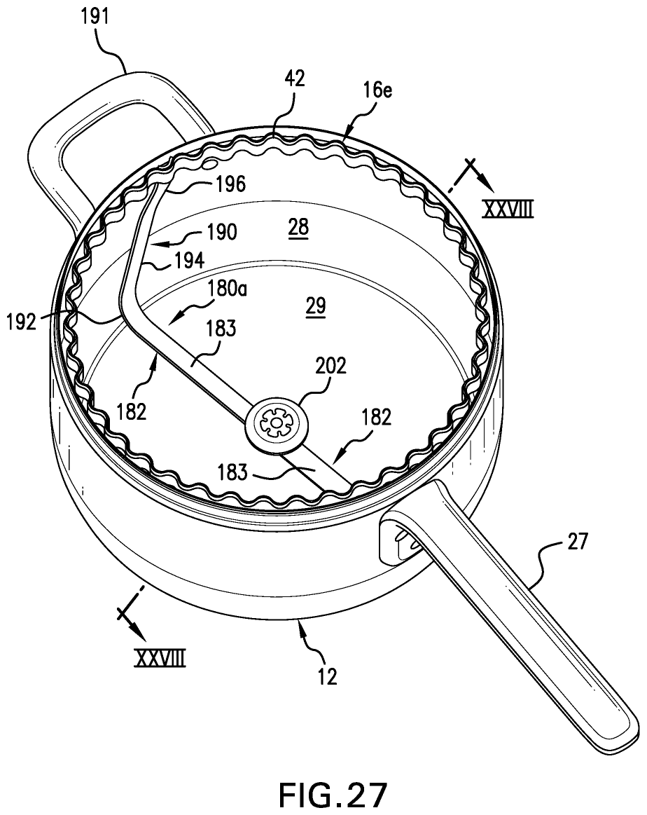

FIGS. 27-29 depict another alternative embodiment of the agitator assembly 16 in the form of an agitator assembly 16e. The agitator assembly 16e is substantially identical to the agitator assembly 16d, with the exception that the agitator assembly 16d includes a post 200 in lieu of the post 160, and a knob 202 that threadably engages the post 200 to retain the agitator assembly 16e on the post 200 while permitting the agitator assembly 16e to rotate in relation to the post 200.

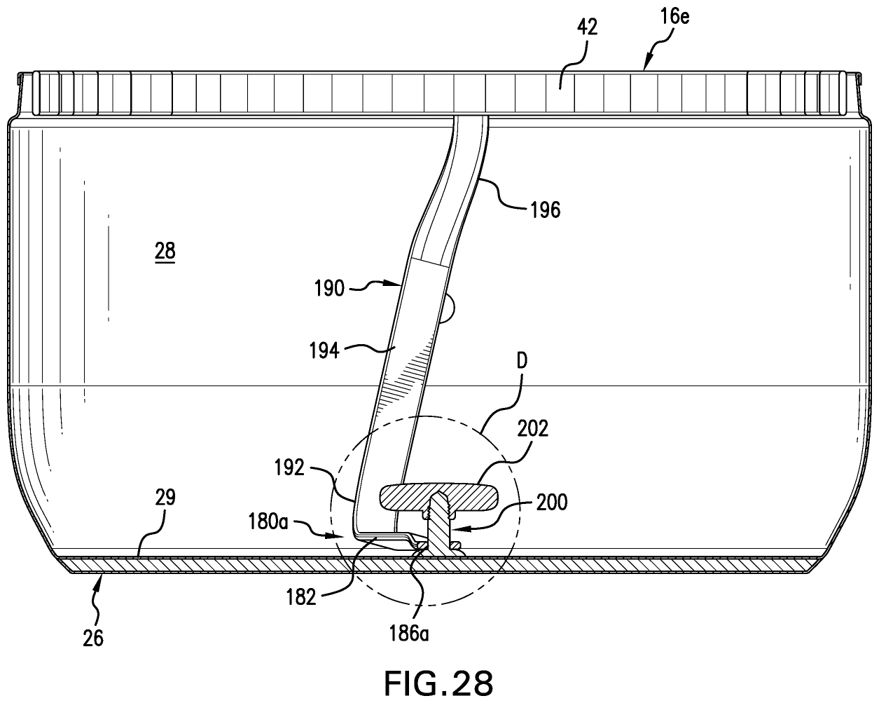

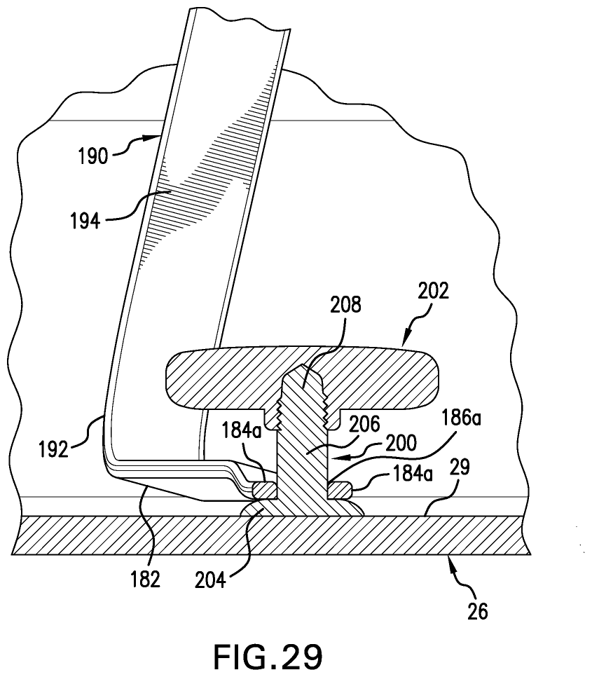

Referring to FIGS. 28 and 29, the post 200 has a base 204, a body 206 that adjoins and extends upward from the base 204, and a threaded upper portion 208 that adjoins the body 206. The base 204 is secured to the upper surface 29 of the disk 26, by a suitable means such as adhesive. The base 204 is positioned at the approximate geometric center of the upper surface 29.

An intermediate member 184a of a lower portion 180a of the agitator assembly 16e has a round through hole 186a formed therein. The through hole 186a is sized to receive the body 206 of the post 200 with minimal clearance, so that the agitator assembly 16e can rotate smoothly about the post 200 as the intermediate member 184a rests on the base 204.

The knob 202 has internal threads configured to engage the treads on the upper portion 208 of the post 200. The knob 202, when engaging the post 200 retains the agitator assembly 16e on the pot assembly 12 by preventing the intermediate member 184a from disengaging from the post 200. Thus, the agitator assembly 16e will remain in place within the pot assembly 12 as the user tilts or inverts the pot assembly 12 to empty the popped kernels 36 from the pot assembly 12.

The user can remove the agitator assembly 16e from the pot assembly 12 by unscrewing and removing the knob 202, and lifting the agitator assembly 16e so that the intermediate member 184a disengages from the post 200.

Lid 17

Referring to FIGS. 1-3 and 12, the lid 17 has a curvilinear lower portion 70, and a substantially flat upper portion 72 that adjoins the lower portion 70. The grip 19 is mounted on the upper portion 72, and is connected to the linkage 18 so that the user can actuate the linkage 18 by turning the grip 19. The lid 17 is configured to mate with the pot 20 as shown in FIGS. 1 and 3, so that the lid 17 covers and encloses the interior volume 34 of the pot assembly 12. As can be seen in FIG. 3, the lower portion 70 of the lid 17 is located outward of the lip 25 of the pot 20; and the lower portion 70 rests on, and is supported by a step 74 formed in the pot assembly 12 at the junction of the pot 20 and the lip 25. The lower portion 70 is sized to fit snugly over the lip 25, to help retain the lid 17 on the pot assembly 12 and inhibit relative moment between the lid 17 and the pot assembly 12 as the user turns the grip 19.

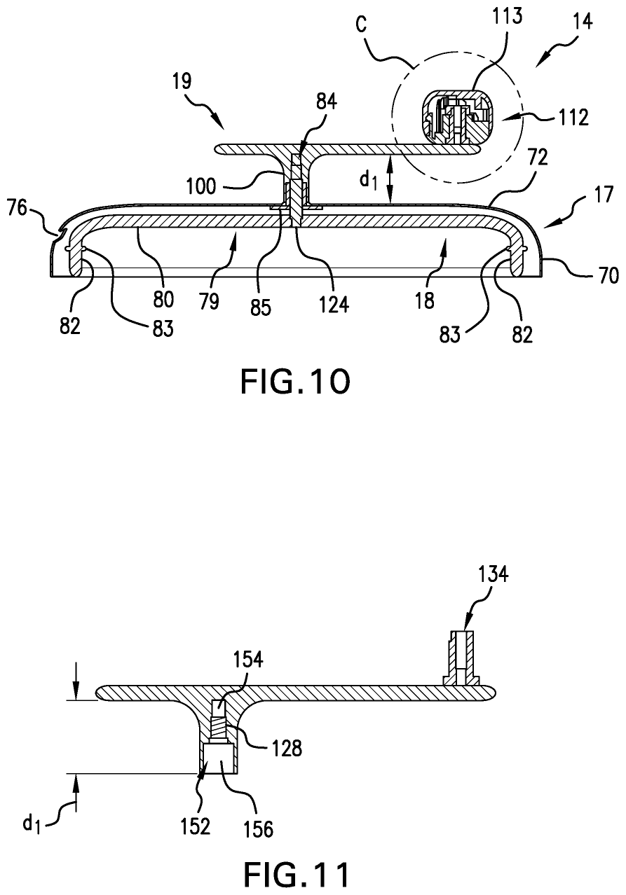

The lid 17 has an elongated opening 76 formed therein. The opening 76 is depicted in FIGS. 3 and 10. The opening 76 extends between the exterior and interior surfaces of the lid 17. The opening 76 functions as a vent that allows steam and heated air to exit the interior volume 34 of the pot assembly 12, to prevent the build-up of excessive pressure within the pot assembly 12 as the kernels 36 are heated and popped. The opening 76 has an arcuate, upwardly-curved shape. The opening 76 can have other shapes in alternative embodiments. Also, more than one of the openings 76 can be formed in the lid 17 in alternative embodiments.

The lid 17 is formed from a rigid material suitable for use at the temperatures generated by a conventional stovetop burner, and suitable for contact with food to be consumed by humans. For example, the lid 17 can be formed from aluminum. The lid 17 can be formed from other types of materials, such as stainless steel or cast iron, in the alternative.

Linkage 18

The linkage 18 is configured to transfer user-generated torque from the grip 19 to the agitator assembly 16, to impart rotation to the agitator assembly 16. Referring to FIGS. 3 and 10-12, the linkage 18 includes a lower bar 79. The lower bar 79 comprises an elongated cross member 80, and two arms 82 that adjoin, and extend downward from the opposite ends of the cross member 80, so that the arms 82 are generally perpendicular to the cross member 80. The arms 82 and the cross member 80 are unitarily formed. The arms 82 and the cross member 80 can be formed separately, and can be securely connected by a suitable means such as welding in alternative embodiments.

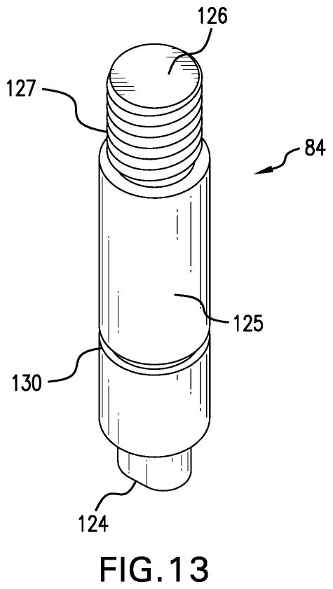

The linkage 18 also includes a pin or upper bar 84, shown individually in FIG. 13. A first, or lower portion 124 of the upper bar 84 is configured to engage the cross member 80, so that torque can be transferred between the upper bar 84 and the lower bar 79 by way of the lower end portion 124. In particular, the lower portion 124 has an elongated shape. The cross member 80 has a through hole formed at the geometric enter thereof. The through hole has a shape that approximately matches that of the lower portion 124, and is size to accept the lower portion 124 with minimal clearance so that the lower bar 79 can rotate smoothly with the upper bar. The lower portion 124 is fixed to the cross member 80 by a suitable means such as welding. The upper bar 84 can be unitarily formed with the cross member 80 in other alternative embodiments.

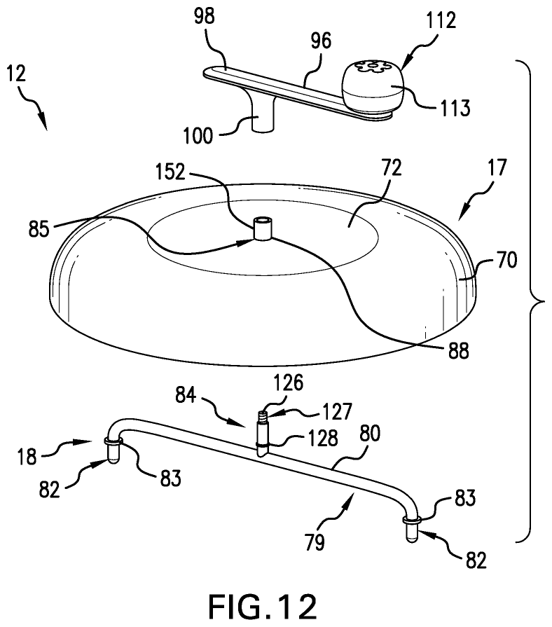

Referring to FIG. 12, the upper bar 84 projects upward from the cross member 80, so that the upper bar 84 is generally perpendicular to the cross member 80. The cross member 80 and the two arms 82 are symmetrically disposed about the upper bar 84. The cross member 80 and the arms 82 can be non-symmetrically-disposed about the upper bar 84 in alternative embodiments.

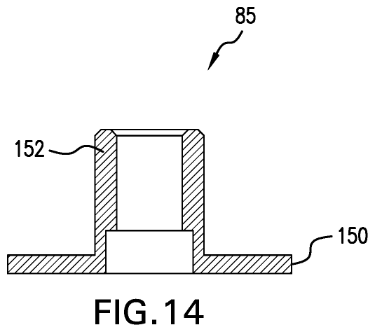

The upper bar 84, and a lower portion of the shaft 100 of the grip 19, extend into a through hole 88 formed in the upper portion 72 of the lid 17 at the approximate center of the lid 17. The through hole 88 is depicted in FIG. 12. As can be seen in FIGS. 10 and 12, a bushing 85 is disposed in the through hole 88, between the upper bar 84 and the periphery of the through hole 88. Referring to FIG. 14, the bushing 85 incudes a circular base 150, and a cylindrical sleeve 152 that adjoins the base 150. The base 150 is fixed to an underside of the upper portion 72 of the lid 17 by a suitable means such as a resistance weld. The sleeve 152 is configured to extend through the through hole 88 with minimal clearance between the sleeve 152 and the periphery of the through hole 88. As can be seen in FIG. 12, a portion of the sleeve 152 projects above the upper surface of the upper portion 72. The sleeve 152 is configured to receive an intermediate portion of the upper bar 84 with minimal clearance, so that the upper bar 84 can rotate in relation to the sleeve and the lid 17. The intermediate portion 125 of the upper bar 84 adjoins the lower portion 124, as can be seen in FIG. 13.

The upper bar 84 also includes an upper portion 126 that adjoins the intermediate portion 125, as shown in FIG. 13. The upper portion 126 extends above the upper surface of the upper portion 72 of the lid 17. The upper portion 126 is fixed to the grip 19. In particular, the upper portion 126 has external threads 127 that mate with internal threads 128 within the grip 19. The threads 128 are visible in FIG. 11. The secure coupling of the grip 19 to the upper bar 84 allows torque to be transferred from the grip 19 to the cross member 80 and the adjoining arms 82, and ultimately to the agitator assembly 16, by way of the upper bar 84. The upper bar 84 can be secured to the grip 19 by means other than threads, in alternative embodiments.

Also, can be seen in FIGS. 3 and 10, the shaft 100 of the grip 19 rests on, and is supported by an upper surface of the base 150 of the bushing 85. Thus, the upper bar 84 and the lower bar 79 are suspended from the lid 17 by way of the bushing 84, and the coupling of the upper bar 84 to the grip 19. The upper bar 84, and the attached lower bar 79 and grip 19, are restrained from upward movement in relation to the lid 17 by a snap ring 128 positioned in a groove 130 formed in the intermediate portion 125 of the upper bar 84.

The lower bar 79, the upper bar 84, and the bushing 85 can be formed from a rigid and durable material suitable for contact with food to be consumed by humans. For example, the cross member 80, arms 82, upper bar 84, and bushing 85 can be formed from stainless steel; other types of materials can be used in the alternative. The cross member 80, arms 82, and upper bar 84 each have a substantially circular cross section. The cross member 80, arms 82, and upper bar 84 can have other types of cross sections in alternative embodiments.

The downwardly-extending arms 82 are configured to engage the ring 42 of the agitator assembly 16, as shown in FIG. 3. More specifically, the length of the cross member 80 is selected so that each arm 82 engages an inwardly-facing surface of corresponding one of the undulations 44 in the ring 42 when the lid 17 is fully engaged with the pot assembly 12. In alternative embodiments, the arms 82 can be configured to engage inwardly-facing surfaces of the undulations 44. As can be seen in FIG. 3, the particular undulations 44 engaged by the arms 82 are located in diametrically opposite positions along the circumference of the ring 42. Each arm 82 has a rim 83 that engages the upper edge of the ring 42 when the lid 17 is fully engaged with the pot assembly 12. The rims 83 are visible in FIG. 12.

The length of the cross member 80 is selected so that each arm 82 fits snugly against its associated undulation 44; and the arms 82, in combination, cause the ring 42 to resiliently deflect as the arms 82 engage the ring 42. The engagement of the arms 82 and the associated undulations 44 causes the arms 82 to transmit torque to the agitator assembly 16 by way of the ring 42. Also, because the arms 82 are symmetrically disposed about the upper bar 84, and the upper bar 84 is substantially aligned with the centerline CL of the pot assembly 12, the linkage 18 helps to centers the agitator assembly 16 within the internal volume 34 of the pot assembly 12.

Alternative embodiments of the linkage 18 can be configured with only one arm 82, and with the cross member 80 extending radially outward from the upper bar 84 in only one direction, so that the cross member 80 is non-symmetrically disposed about the upper bar 84. Other alternative embodiments of the linkage 18 can include more than one cross-member 80, and more than two arms 82. In other alternative embodiments of the device 10, the linkage 18 or the grip 19 can be connected directly to the arms 45. In such embodiments, the agitator assembly 16 can be equipped without the ring 42.

Grip 19

Referring to FIGS. 1-3 and 10-12, the grip 19 incudes a first arm 96, and a second arm 98 that adjoins the first arm 96. The grip 19 also includes a shaft 100 that adjoins, and extends downward from the first and second arms 96, 98, so that the shaft 100 has a generally perpendicular orientation in relation to the first and second arms 96, 98. The first arm 96, the second arm 98, and the shaft 100 are unitarily formed. The first 96, second arm 98, and shaft 100 can be formed separately, and can be joined by a suitable means such as welding in alternative embodiments. The first and second arms 96, 98 have a generally flat profile, giving the first and second arms 96, 98 a relatively large surface area. The large surface area helps to dissipate heat transferred to the first and second arms 96, 98 during the popcorn popping process. Also, the configuration of the first and second arms 96, 98 allows the user to lift the lid assembly 14 by way of the grip 19 with relative ease and comfort. The grip 19 can be formed from a rigid and durable material such as stainless steel; the grip 19 can be formed from other types of materials in the alternative.

Referring to FIG. 11, the shaft 100 has an interior passage 152 that receives the upper portion 126, and the intermediate portion 125 of the upper bar 84. In particular, the interior passage 152 has an upper portion 154 bordered by the threads 128 that couple the grip 19 to the upper bar 84. The interior passage 152 also includes a relatively large-diameter lower portion 156 that receives the portions of the bushing 85 and the intermediate portion 125 that projected extend above the lid 17. As can be seen in FIGS. 3 and 10, a lowermost surface of the shaft 100 is slightly elevated in relation to the upper portion 72 of the lid 17, adjacent the through hole 88. A lowermost surface of the shaft 100 of the grip 19 rests on an upper surface of the base 150 of the bushing 85.

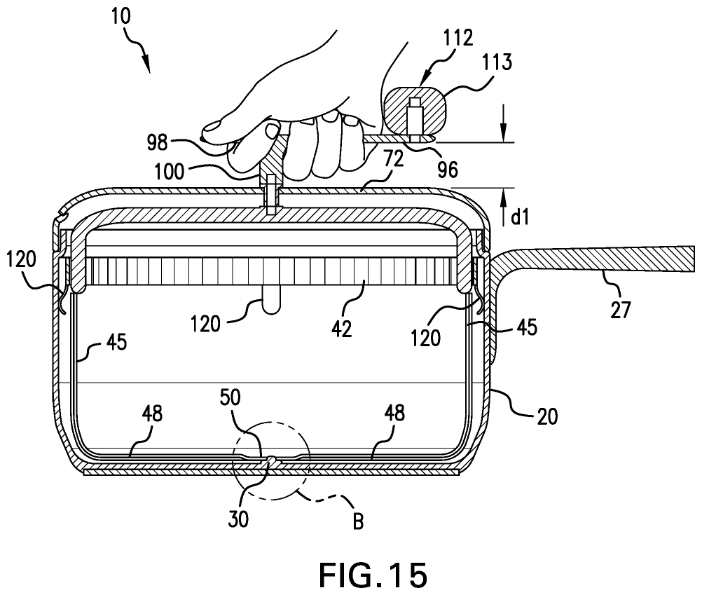

The first and second arms 96, 98 are spaced from an exterior surface of the upper portion 72 of the lid 17 by a distance about equal to the length, or vertical dimension, of the shaft 100. This distance is denoted in FIGS. 1 and 15 by the character “dl.” The length of the shaft 100 can be selected so that the distance dl is sufficient to prevent the grip 19 from experiencing excessive heating during the popcorn popping operation due to heat emitted from the lid 17. For example, the distance “dl” can be about 23.5 mm.

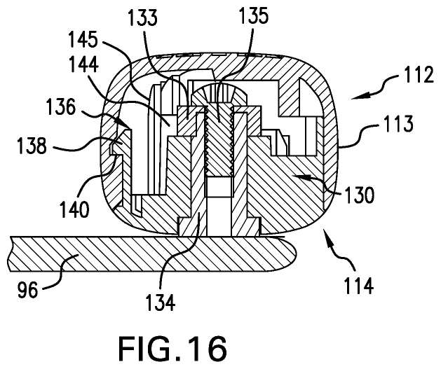

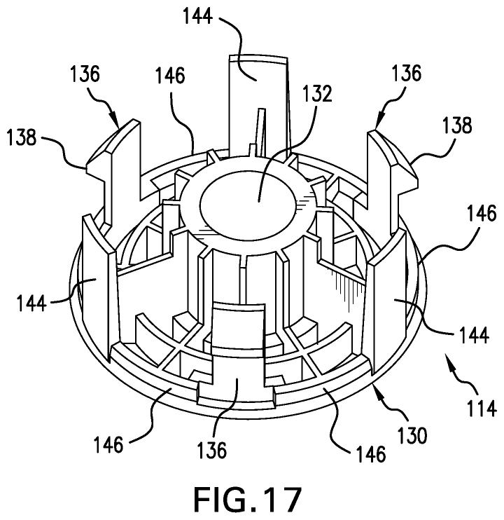

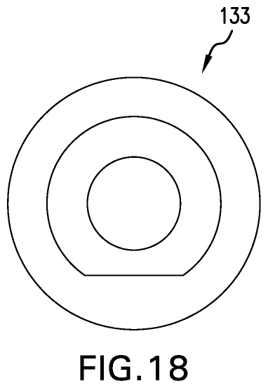

The grip 19 also includes a knob 112, visible in FIGS. 1-3, 16, and 17. The knob 112 is mounted on a freestanding end of the first arm 96 of the grip 19. The knob 112 includes an upper portion 113, and a lower portion 114 configured to mate with the upper portion 113. Referring to FIG. 17, the lower portion 114 comprises a body 130 having a cylindrical passage 132 centrally formed therein. The passage 132 is configured to receive an upwardly-extending post 134 fixed to the first arm 96, proximate the freestanding end thereof. The post is visible in FIG. 11. The passage 132 is sized to receive the post 134 with minimal clearance, so that the lower portion 114, and the attached upper portion 113, can rotate smoothly in relation to the post 134. Referring to FIG. 16, the lower portion 114 is retained on the post 134 by a threaded fastener 135 that engages internal threads within the post 134, and a washer 133 located between the head of the fastener 135 and the body 130. The washer 134 is depicted individually in FIG. 18.

The lower portion 114 of the knob 112 also includes a plurality of clips 136 that adjoin, and extend from the body 130, as shown in FIG. 17. The clips 136 are configured to extend into an interior volume within the upper portion 113 when the upper portion 113 and the lower portion 114 are mated. Each clip 136 has an overhanging edge 138 proximate an upper end thereof. The edge 138 engages an angled ledge or step 140 within the interior volume of the upper portion 113 when the upper portion 113 and the lower portion 114 are fully mated, as shown in FIG. 16. The steps also are visible in FIG. 16. The clips 136 are configured to resiliently deflect as the upper end of the clip 136 passes over the step 140. Once the upper end of the clip 136 has passed over the step 140, the resilience of the clip 136 gives rise to a frictional force between the contacting surfaces of the edge 138 and the step 140. This force helps to retain the upper portion 113 on the lower portion 114.

The lower portion 114 of the knob 112 also includes a plurality of arms 144 that adjoin, and extend upward from the body 130, as shown in FIG. 17. The arms 144 are configured to extend into the interior volume of the upper portion 113, and to engage ribs 145 formed on an interior surface of the upper portion 113, as shown in FIG. 16. The ribs 145 are visible in FIG. 16. The engagement of the arms 144 and the ribs 145 restrains the upper portion 113 from rotating in relation to the lower portion 114.

Referring to FIG. 17, the body 130 has a circumferentially-extending lip 146 formed thereon. The lip 146 is configured to extend into a downwardly-facing groove (not shown) formed in the upper portion 113 when the upper portion 113 and the lower portion 114 are mated, as shown in FIG. 16. Contact between the lip 146 and the contacting surfaces of the upper portion 113 helps to restrain the upper portion 113 from lateral movement in relation to the lower portion 114.

The upper portion 113 and the lower portion 114 of the knob 112, and the washer 133 can be formed, for example, from nylon. The upper portion 113, lower portion 114, and washer 133 can be formed from other materials in the alternative.

In alternative embodiments, the knob assembly 112 or the linkage 18 can be connected directly to the lower portion 46 of the agitator assembly 16. In such embodiments, the agitator assembly 16 can be equipped without the ring 42 and/or the arms 45.

Another alternative embodiment can be configured without the linkage 18, and without the ring 42 and the arms 45 of the agitator assembly 16. The lower portion 46 of the agitator assembly 16 can be connected to the grip 19 by a multi-piece post or shaft. The shaft can be configured so that an upper portion of the shaft separates from a lower portion of the shaft when the lid assembly 14 is lifted from the pot assembly 12, while the lower portion of the shaft remains in the pot assembly 12 along with the agitator assembly.

Operation

The user can spin the agitator assembly 16 by rotating the grip 19. The user can rotate the grip 19 by exerting a force on the upper portion 113 of the knob 112, in a direction substantially perpendicular to the lengthwise axis of the first arm 96. The user-generated force is transferred to the lower portion 114 of the knob 112, which in turn transfers the force to the post 134 fixed to the first arm 96 of the grip 19. The post 134 transfers the force the end of the first arm 96.

The first arm 96, in response to the force applied thereto, exerts a torque on the shaft 100. The shaft 100 transmits this torque to the linkage 18 by way of the upper bar 84, causing the cross member 80 and the adjoining arms 82 to rotate about the centerline CL of the pot assembly 12. The arms 82, in turn, impart rotation to the agitator assembly 16 by way of the ring 42, which the arms 82 securely engage by way of their associated undulations 44. As can be seen in FIGS. 1-3, the first arm 96 is relatively long, so that the user easily can produce a torque on the shaft 100 sufficient to rotate the agitator assembly 16. As discussed above, the blades 48 of the agitator assembly 16 scoop and lift the un-popped kernels 36, and popped corn, from the upper surface 29 of the disk 26 of the pot assembly 12 as the blades 48 rotate proximate the upper surface 29.

The user can rotate the agitator assembly 16 in the above manner on a periodic basis as the kernels 36 are being popped within the device 10, to prevent the kernels 36 and the popped corn from sticking to the surface 29 and burning. Also, the arms 45 of the agitator assembly 16, which are located proximate the interior surface 28 of the pot 20, stir the popped corn within the interior volume 34 and help to discourage popped corn from sticking to the interior surface 28 and burning.

After substantially all of the kernels 36 have been popped, the user can remove the device 10 from the heating source using the handle 27, and the user can lift the lid assembly 14 off of the pot assembly 12 to facilitate removal of the popped corn. The grip 19 is configured so that the grip 19 can act as a handle by which the user can remove the lid assembly 14 from the pot assembly 12. More specifically, as shown in FIG. 15, the first and second arms 96, 98 of the grip 19 are positioned on opposite sides of the shaft 100; and the first and second arms 96, 98 project outward from the shaft 100 by a sufficient distance to permit the user to simultaneously grasp both the first arm 96 and the second arm 98 with one hand, with the user's hand straddling the shaft 100. For example, as can be seen in FIG. 15, the first and second arms 96, 98 can be configured so that the user can grip the second portion 98 with the user's thumb and index finger, while simultaneously gripping the first portion 96 with the remaining three fingers of the same hand.

Also, due the relatively large surface areas of the first and second arms 96, 98, and the spacing between the first and second arms 96, 98 and the upper portion 72 of the lid 17, the first and second arms 96, 98 will remain cool enough to the grasped by the user at the time the popcorn popping process is completed.

The arms 82 of the linkage 18 automatically disengage from the agitator assembly 16 as the lid assembly 14 is lifted from the pot assembly 12. In particular, the weight of agitator assembly 16, in combination with the weight of the popped corn acting on the lower portion 46 of the agitator assembly 16, will be sufficient to overcome the friction between each of the arms 82 and its associated undulation 44 on the ring 42, and the additional friction between the clips 120 and the adjacent surface 28 of the pot 20. Thus, the agitator assembly 16 can remain within the pot assembly 12, and largely out of the way as the popped corn is emptied from the pot assembly 12. This feature helps to avoid the spillage of the popped corn that often occurs in conventional popcorn poppers with stirring means that do not disconnect from the lid as the lid is lifted from the pot. Also, because the individual components of the agitator assembly 16 are located proximate the interior surfaces 28, 29 of the pot assembly 12, the agitator assembly 16 does not interfere with the emptying of the popped corn from the pot assembly 12.

After the popped corn has been emptied from the pot assembly 12, the agitator assembly 16 can be removed for cleaning or other purposes by lifting the agitator assembly 16 out of pot assembly 12, without any need to remove fasteners or otherwise disassemble any components of the device 10.

We claim:

1. A device for popping corn, comprising:
a pot comprising one or more interior surfaces defining an interior volume of the pot;
a lid assembly comprising: a lid configured to mate with the pot; a crank coupled to and configured to rotate in relation to the lid; and a linkage coupled to and configured to rotate with the crank; and
an agitator assembly configured to be positioned within the interior volume of the pot, and to releasably engage the linkage when the lid is mated with the pot.

2. The device of claim 1, wherein the agitator assembly is further configured to disengage from the lid assembly when the lid assembly is removed from the pot.

3. The device of claim 1, wherein:
the agitator assembly comprises a rim, a lower portion, and at least one arm;
the lower portion comprises at least one blade configured to engage kernels of un-popped corn resting on at least one of the one or more interior surfaces of the pot; and
the at least one arm comprises a first end connected to the rim, and a second end connected to the lower portion.

4. The device of claim 3, wherein the linkage comprises: a bar connected to the grip; a cross member connected to the bar, and at least one arm connected to the cross member and configured to removably engage the rim of the agitator assembly.

5. The device of claim 4, wherein the at least one arm of the linkage is further configured to disengage from the rim when the lid assembly is removed from the pot.

6. The device of claim 5, wherein:
the rim of the agitator assembly comprises a plurality of undulations; and
the at least one arm of the linkage is configured to removably engage the rim via one of the undulations when the agitator assembly is removably engaged with the linkage.

7. The device of claim 1, wherein the lid has an arcuate opening formed therein and extending between interior and exterior surfaces of the lid.

8. The device of claim 1, wherein the crank comprises:
a shaft having a first end configured to be connected to the linkage, the shaft extending from the lid in a first direction;
a first arm connected to a second end of the shaft, the first arm extending from the shaft in a second direction substantially perpendicular to the first direction; and
a second arm connected to the second end of the shaft and to an end of the first arm, the second arm extending from the first arm and the shaft in a third direction substantially perpendicular to the first direction and substantially opposite the second direction.

9. The device of claim 3, further comprising a post secured to the pot and located within the interior volume of the pot, wherein:
the post comprises a base, a body adjoining the base, and a key that adjoins the body;
the post is configured to engage the lower portion of the agitator assembly;
the agitator assembly is configured rotate about the post;
the lower portion of the agitator has a through hole formed therein and configured to receive the body of the post; and
the through hole is configured so that the lower portion of the agitator can be separated from the post only when the a keyhole portion and the key are aligned.

10. The device of claim 3, further comprising a post secured to the pot and located within the interior volume of the pot; and a knob, wherein:
the post comprises a base, a body adjoining the base, and a key that adjoins the body;
the post is configured to engage the lower portion of the agitator assembly;
the agitator assembly is configured rotate about the post;
the lower portion of the agitator has a through hole formed therein and configured to receive the body of the post; and
the knob is configured to threadably engage the post, and to retain the lower portion of the agitator assembly on the post.

11. A device for popping corn, comprising:
a pot comprising one or more interior surfaces defining an interior volume of the pot;
a lid assembly comprising: a lid configured to mate with the pot; a crank coupled to and configured to rotate in relation to the lid; and a linkage coupled to and configured to rotate with the crank; and
an agitator assembly configured to be positioned within the interior volume of the pot, wherein:
the agitator assembly comprises at least one arm configured to be coupled to the linkage so that the agitator assembly rotates with the linkage, and a lower portion connected to the at least one arm; and
the at least one arm is laterally offset from an axis of rotation of the agitator assembly.

12. The device of claim 11, wherein the lower portion comprises at least one blade configured to engage kernels of un-popped corn resting on at least one of the one or more interior surfaces of the pot.

13. The device of claim 11, wherein a distance between the at least one arm and the axis of rotation of the agitator assembly is greater than a distance between the at least one arm and a sidewall of the pot when the agitator assembly is positioned within the interior volume of the pot.

14. The device of claim 11, wherein the agitator assembly further comprises a rim; a first end of the at least one arm is connected to the rim; and a second end of the at least one arm is connected to the lower portion of the agitator assembly.

15. The device of claim 14, wherein the linkage comprises: a bar connected to the crank; a cross member connected to the bar, and at least one arm connected to an end of the cross member and configured to engage the rim of the agitator assembly.

16. A device for popping corn, comprising:
a pot comprising a sidewall having an interior surface, and a bottom adjoining the sidewall and having an upper surface, the interior surface of the sidewall and the upper surface of the bottom defining an interior volume of the pot; and
an agitator assembly comprising at least one blade, the agitator assembly configured to be positioned within the interior volume of the pot, and to rotate in relation to the pot, wherein:
the pot is configured to hold kernels of un-popped corn within the interior volume of the pot; and
the at least one blade is configured to contact the un-popped kernels of corn resting on the upper surface of the bottom of the pot, and to cause the un-popped kernels of corn resting on the upper surface of the bottom of the pot to tumble as the agitator assembly rotates in relation to the pot.

17. The device of claim 16, wherein the at least one blade is angled in relation to the upper surface of the bottom of the pot.

18. The device of claim 16, wherein: the at least one blade has a leading edge; and the leading edge is spaced apart from the upper surface of the bottom of the pot.

19. The device of claim 16, wherein the at least one blade comprises an upper surface, and the at least one blade is configured so that the un-popped kernels of corn resting on the upper surface of the bottom of the pot are lifted up and over the upper surface as the agitator assembly rotates in relation to the pot.

20. The device of claim 16, wherein:
the at least one blade comprises a first and a second blade;
the agitator assembly further comprises:
a rim;
a first and a second arm each having a first end connected to the rim, and a second end; and
a lower portion comprising the first and second blade, and an intermediate portion adjoining, and positioned between the first and second blades;
the second end of the first arm of the agitator assembly is connected to the first blade; and
the second end of the second arm of the agitator assembly is connected to the second blade.
